(19) United States
(12) Patent Application Publication
(10) Pub. No.: US 2025/0063017 A1
(43) Pub. Date: Feb. 20, 2025

(54) 5G USER TERMINAL IP ADDRESS CONFIRMATION METHOD, APPARATUS AND SYSTEM

(71) Applicant: E SURFING IOT CO., LTD., Guangzhou, Guangdong (CN)

(72) Inventor: Yan TANG, Guangzhou, Guangdong (CN)

(21) Appl. No.: 18/724,862

(22) PCT Filed: Dec. 23, 2022
(86) PCT No.: PCT/CN2022/141326

§ 371 Date: Aug. 8, 2024

(30) Foreign Application Priority Data
Dec. 29, 2021 (CN) 202111638320.6

(51) Int. Cl. H04L 61/5007; H04L 61/5061; H04W 28/08; H04W 76/10

(52) U.S. Cl. CPC H04L 61/5007; H04L 61/5061; H04W 28/08; H04W 76/10

(57) ABSTRACT

A method for determining an IP address of a 5G user terminal is disclosed. A SMF determines a target DNN matching the SMF and a type of a terminal address pool for the target DNN. For dynamic configuration, the SMF configures a first UPF and a second UPF in a load balancing mode, and the first UPF or the second UPF selects an IP address from respective IP address pools as a dynamic IP address of the user terminal accessing the target DNN. For fixed acquisition, the SMF configures the first UPF and the second UPF in an active-standby mode, and the first UPF or the second UPF as an active apparatus determines a fixed IP address of the user terminal accessing the target DNN from the respective IP address pool.

### TECHNICAL FIELD

The present disclosure relates to the technical field of 5G, and particularly, to a method, apparatus, and system for determining an Internet Protocol (IP) address of a 5G user terminal.

### BACKGROUND

User Plane Function (UPF) is a network element entity in a 5G core network responsible for user plane management, including functions such as Protocol Data Unit (PDU) session management, routing switching. When a user terminal establishes a connection with the UPF, an IP address is needed to establish a PDU session through the IP address. The method for allocating the IP address to the user terminal is generally determined by its service type. Currently, the allocation method mainly includes a dynamic allocation mode and fixed acquisition. In the dynamic allocation mode, the IP address of the user terminal is allocated by a Session Management Function (SMF)/User Plane Function (UPF). The SMF/UPF selects an unallocated address from the configured IPPOOL and allocates it to the user terminal. The current network topology typically uses two or more UPF apparatuses to share the load. When a UPF apparatus fails and cannot carry services, the user can go online again and register with a normal apparatus to achieve disaster recovery, thereby ensuring high service reliability. Fixed acquisition means writing the IP address in subscription data of Unified Data Management (UDM). The address of the user terminal is no longer allocated by the SMF/UPF, and the user terminal always uses the IP address in the UDM. The SMF directly obtains the IP address of the user terminal through the UDM.

Data Network Name (DNN) contains a plurality of user terminals, which are mainly used to distinguish user terminals from different data networks. Different DNNs are configured with different SMFs and UPFs. In the existing technology, generally user terminals in the same data network or user terminals of the same service type will be allocated to the same DNN, and the SMF and UPF matching the DNN can only be configured with the IP address allocation mode that matches the service type of the user terminal in the DNN. For example, allocation methods corresponding to the service type of the user terminal under one DNN are fixed acquisition, and the UPF matching the DNN can only be configured by the SMF as fixed acquisition. Moreover, in the existing technology, fixed acquisition networking generally uses a single UPF, but single-point deployment loses disaster recovery.

### SUMMARY

Embodiments of the present disclosure provide a method, apparatus, and system for determining an Internet Protocol (IP) address of a 5G user terminal, where the UPF can be configured for different DNNs to satisfy different usage requirements, thereby improving the disaster recovery.

In a first aspect, an embodiment of the present disclosure provides a method for determining an Internet Protocol (IP) address of a 5G user terminal, including:
determining, by a Session Management Function (SMF) and according to preset configuration information, a target Data Network Name (DNN) that matches with the SMF, and determining a type of a terminal address pool configured for the target DNN;
in response to the type of the terminal address pool configured for the target DNN being a dynamic configuration, configuring, by the SMF, the first UPF and the second UPF in a load balancing mode to allocate IP addresses of the terminal address pool to the first UPF and the second UPF in a preset proportion, and selecting, by the first UPF or the second UPF, an IP address from respective IP address pools as a dynamic IP address of the user terminal accessing the target DNN, wherein the user terminal is capable of establishing a PDU session with the first UPF or the second UPF through the dynamic IP address; and
in response to the type of the terminal address pool configured for the target DNN being a fixed acquisition, configuring, by the SMF, the first UPF and the second UPF in an active-standby mode to allocate the terminal address pool to both the first UPF and the second UPF, and determining, by one of the first UPF and the second UPF which is configured as an active apparatus, a fixed IP address of the user terminal accessing the target DNN from the respective IP address pool, where the user terminal is capable of establishing the PDU session with the active apparatus through the fixed IP address.

In a second aspect, an embodiment of the present disclosure further provides an apparatus for determining an Internet Protocol (IP) address of a 5G user terminal, including:
determining, by a Session Management Function (SMF) and according to preset configuration information, a target Data Network Name (DNN) that matches with the SMF, and determining a type of a terminal address pool configured for the target DNN;
in response to the type of the terminal address pool configured for the target DNN being a dynamic configuration, configuring, by the SMF, the first UPF and the second UPF in a load balancing mode to allocate IP addresses of the terminal address pool to the first UPF and the second UPF in a preset proportion, and selecting, by the first UPF or the second UPF, an IP address from respective IP address pools as a dynamic IP address of the user terminal accessing the target DNN, where the user terminal is capable of establishing a PDU session with the first UPF or the second UPF through the dynamic IP address; and
in response to the type of the terminal address pool configured for the target DNN being a fixed acquisition, configuring, by the SMF, the first UPF and the second UPF in an active-standby mode to allocate the terminal address pool to both the first UPF and the second UPF, and determining, by one of the first UPF and the second UPF which is configured as an active apparatus, a fixed IP address of the user terminal accessing the target DNN from the respective IP address pool, where the user terminal is capable of establishing the PDU session with the active apparatus through the fixed IP address.

In an embodiment, after determining, by a Session Management Function (SMF) and according to preset configuration information, a target Data Network Name (DNN) that matches with the SMF, and determining a type of a terminal address pool configured for the target DNN, the method further includes:
in response to the target DNN being configured with both the terminal address pool with the type of dynamic configuration and the terminal address pool with the type of fixed acquisition, allocating the IP addresses in the terminal address pool with the type of dynamic configuration evenly to the first UPF and the second UPF so as to configure the first UPF and the UPF in the load balancing mode; and
allocating the IP addresses in the terminal address pool with the type of fixed acquisition to both the first UPF and the second UPF so as to configure the first UPF and the second UPF in the active-standby mode.

In an embodiment, the method further includes:
in the active-standby mode and in a case that the first UPF is the active apparatus, in response to the first UPF failing, interrupting, by the first UPF, the PDU session with the user terminal to enable the user terminal to establish the PDU session with the second UPF.

In an embodiment, after in response to the first UPF failing, interrupting, by the first UPF, the PDU session with the user terminal to enable the user terminal to establish the PDU session with the second UPF, the method further includes:
in response to the second UPF receiving a downlink message sent to the user terminal by a data network, determining whether an uplink message corresponding to the downlink message exists in the second UPF;
in response to the uplink message corresponding to the downlink message not existing in the second UPF, determining whether the first UPF returns to normal; and
in response to the first UPF returning to normal, forwarding the downlink message to the first UPF.

In an embodiment, forwarding the downlink message to the first UPF includes:
adding a custom tag to the downlink message to indicate that the downlink message is a forwarded message; and
forwarding the downlink message with the custom tag to the first UPF.

In an embodiment, after in response to the first UPF returning to normal, forwarding the downlink message to the first UPF, the method further includes:
in response to the first UPF receiving the downlink message, determining whether the uplink message corresponding to the downlink message exists in the first UPF; and
in response to the uplink message corresponding to the downlink message existing in the first UPF, sending the downlink message to the user terminal.

In an embodiment, after in response to the first UPF receiving the downlink message, determining whether the uplink message corresponding to the downlink message exists in the first UPF, the method further includes:
in response to the uplink message corresponding to the downlink message not existing in the first UPF, discarding the downlink message.

In an embodiment, an apparatus for determining an Internet Protocol (IP) address of a 5G user terminal includes:
an allocation determination unit configured to determine, by a Session Management Function (SMF) and according to preset configuration information, a target Data Network Name (DNN) that matches with the SMF, and determine a type of a terminal address pool configured for the target DNN;
a first processing unit configured to, in response to the type of the terminal address pool configured for the target DNN being a dynamic configuration, configure, by the SMF, the first UPF and the second UPF in a load balancing mode to allocate IP addresses of the terminal address pool to the first UPF and the second UPF in a preset proportion, and to select, by the first UPF or the second UPF, an IP address from respective IP address pools as a dynamic IP address of the user terminal accessing the target DNN, where the user terminal is capable of establishing a PDU session with the first UPF or the second UPF through the dynamic IP address; and
a second processing unit configured to, in response to the type of the terminal address pool configured for the target DNN being a fixed acquisition, configure, by the SMF, the first UPF and the second UPF in an active-standby mode to allocate the terminal address pool to both the first UPF and the second UPF, and to determine, by one of the first UPF and the second UPF which is configured as an active apparatus, a fixed IP address of the user terminal accessing the target DNN from the respective IP address pool, where the user terminal is capable of establishing the PDU session with the active apparatus through the fixed IP address.

In a third aspect, an embodiment of the present disclosure further provides a system for determining an Internet Protocol (IP) address of a 5G user terminal, including:
a first UPF in communication connection to the user terminal and a data network;
a second UPF in communication connection to the user terminal and the data network respectively; and
at least one Session Management Function (SMF) connected to the first UPF and the second UPF respectively, and configured to configure the first UPF and the second UPF according to a type of a terminal address pool configured by a Data Network Name (DNN), where the type of the terminal address pool includes a dynamic configuration and a fixed acquisition, and in the dynamic configuration, the SMF configures the first UPF and the second UPF in a load balancing mode, and in the fixed acquisition, the SMF configures the first UPF and the second UPF in an active-standby mode, the first UPF is an active apparatus, the second UPF is a standby apparatus, and the user terminal preferentially establishes a PDU session through the active apparatus.

Embodiments of the present disclosure provide a method, apparatus, and system for determining an Internet Protocol (IP) address of a 5G user terminal. The method includes: determining, by a Session Management Function (SMF) and according to preset configuration information, a target Data Network Name (DNN) that matches with the SMF, and determining a type of a terminal address pool configured for the target DNN; in response to the type of the terminal address pool configured for the target DNN being a dynamic configuration, configuring, by the SMF, the first UPF and the second UPF in a load balancing mode to allocate IP addresses of the terminal address pool to the first UPF and the second UPF in a preset proportion, and selecting, by the first UPF or the second UPF, an IP address from respective IP address pools as a dynamic IP address of the user terminal accessing the target DNN, where the user terminal is capable of establishing a PDU session with the first UPF or the second UPF through the dynamic IP address; and in response to the type of the terminal address pool configured for the target DNN being a fixed acquisition, configuring, by the SMF, the first UPF and the second UPF in an active-standby mode to allocate the terminal address pool to both the first UPF and the second UPF, and determining, by one of the first UPF and the second UPF which is configured as an active apparatus, a fixed IP address of the user terminal accessing the target DNN from the respective IP address pool, where the user terminal is capable of establishing the PDU session with the active apparatus through the fixed IP address. The SMF in the embodiments of the present disclosure can configure the first UPF and the second UPF according to the type of the terminal address pool configured under the DNN. In the load balancing mode, the first UPF and the second UPF are allocated with the IP addresses in the terminal address pool according to the preset proportion, such that IP addresses can be allocated to the user terminals respectively to facilitate the establishment of PDU sessions with the user terminals. In the active-standby mode, the first UPF and the second UPF have the same IP address pool, and the UPF set as the active apparatus establishes the PDU session with the user terminal, such that regardless of the type of terminal address pool configured for the DNN, the IP address of the user terminal can be allocated through a pair of UPFs, thereby establishing a PDU session with the user terminal, and improving disaster recovery.

### BRIEF DESCRIPTION OF DRAWINGS

In order to more clearly illustrate the technical solutions in the embodiments of the present disclosure, the accompanying drawings required to be used in the description of the embodiments will be briefly introduced below. Obviously, the accompanying drawings in the following description are some embodiments of the present disclosure. For those of ordinary skill in the art, other accompanying drawings can also be obtained based on these accompanying drawings without creative effort.

FIG. 1 is a flowchart of a method for determining an Internet Protocol (IP) address of a 5G user terminal provided in an embodiment of the present disclosure;

FIG. 2 is a schematic structural block diagram of a system for determining an Internet Protocol (IP) address of a 5G user terminal provided in an embodiment of the present disclosure;

FIG. 3 is a schematic structural block diagram of a system for determining an Internet Protocol (IP) address of a 5G user terminal provided in an embodiment of the present disclosure;

FIG. 4 is a schematic structural block diagram of a system for determining an Internet Protocol (IP) address of a 5G user terminal provided in an embodiment of the present disclosure;

FIG. 5 is a schematic structural block diagram of a system for determining an Internet Protocol (IP) address of a 5G user terminal provided in an embodiment of the present disclosure;

FIG. 6 is a schematic block diagram of an apparatus for determining an Internet Protocol (IP) address of a 5G user terminal provided in an embodiment of the present disclosure.

### DETAILED DESCRIPTION

The technical solutions in the embodiments of the present disclosure will be clearly and completely described below with reference to the accompanying drawings in the embodiments of the present disclosure. Apparently; the described embodiments are part of, not all of, the embodiments of the present disclosure. Based on the embodiments of the present disclosure, all other embodiments obtained by those of ordinary skill in the art without making creative efforts fall within the scope of protection of the present disclosure.

It should be understood that, when used in this specification and the appended claims, the terms “comprise” and “include” indicate the presence of described features, integers, operations, elements and/or components, but do not exclude the presence or addition of one or more of other features, integers, operations, elements, components and/or collections thereof.

It should also be understood that the terms used in the specification of the present disclosure are merely for the purpose of describing particular embodiments and are not intended to limit the present disclosure. As used in the specification and appended claims of the present disclosure, the singular forms “one”, “a/an”, and “the” are intended to include the plural forms unless the context clearly dictates otherwise. It is to be further understood that the term “and/or” as used in the specification and appended claims of the present disclosure refers to and includes any and all possible combinations of one or more of the associated listed items.

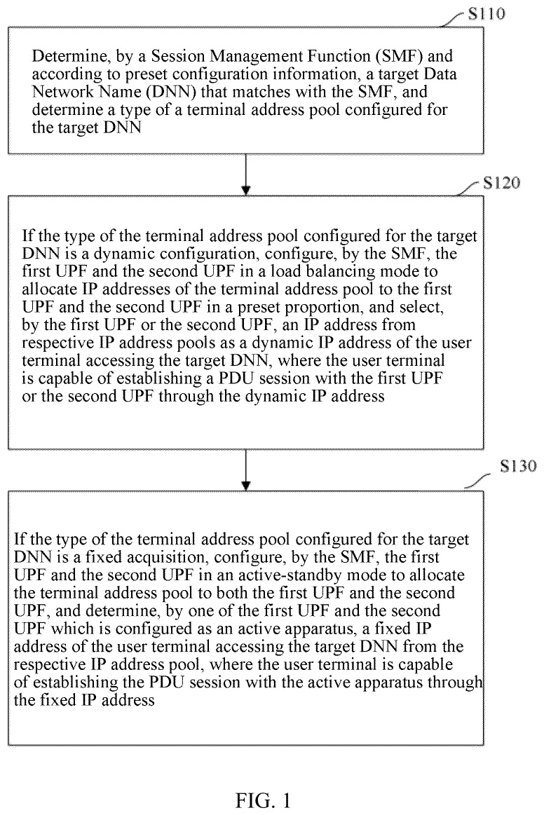

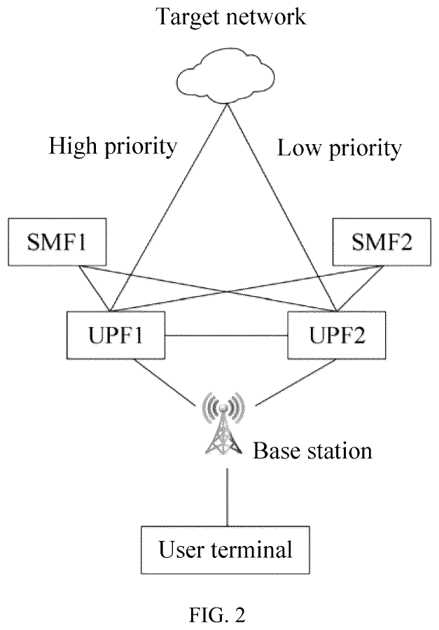

Referring to FIG. 1 and FIG. 2, FIG. 1 is a flowchart of a method for determining an Internet Protocol (IP) address of a 5G user terminal provided in an embodiment of the present disclosure, and FIG. 2 is a structural block diagram of a system for determining an Internet Protocol (IP) address of a 5G user terminal provided in an embodiment of the present disclosure. The method for determining an IP address of a 5G user terminal according to the embodiment of the present disclosure can flexibly select different allocation modes according to different needs. As shown in FIG. 1, the method includes the following steps S110 to S130.

In S110, according to preset configuration information, a Session Management Function (SMF) determines a target Data Network Name (DNN) that matches with the SMF, and determines a type of a terminal address pool configured for the target DNN.

In the embodiment of the present disclosure, in the 5G network, the user terminal (UE) establishes the PDU session with the data network through the core network such that it can communicate with the data network. The core network includes an Access and Mobility Management Function (AMF), a Session Management Function (SMF), a User plane function (UPF), a Unified Data Management (UDM), a DNN and other functions known to those of ordinary skills in the art. Each DNN is configured with at least one SMF and a pair of UPFs, namely a first UPF and a second UPF. The SMF can configure the modes of the first UPF and the second UPF according to the type of terminal address pool currently configured in the DNN. When the user terminal accesses the DNN, it will enter a matching DNN based on its service type. That is, for the user terminal that can be dynamically allocated with the address, the DNN configured with the terminal address pool with the type of dynamic configuration is accessed. For the user terminal only capable of acquiring fixed IP address, the DNN configured with the terminal address pool with the type of fixed acquisition is accessed. For example, when the user terminal needs to connect to a GREVPN network through the UPF, it enters the DNN of the terminal address with the type of fixed acquisition. When the user terminal needs to connect to a public network through the UPF, it enters the DNN of the terminal address with the type of dynamic configuration.

For a configured DNN, the type of the terminal address pool configured under the DNN is determined. For example, if the type of the terminal address pool is dynamic configuration, then the IP addresses in the terminal address pool can be allocated to the first UPF and the second UPF matching the DNN, where the terminal address pool contains a plurality of IP addresses. In load balancing mode, the number of the IP addresses in the IP address pool of the first UPF and the IP address pool of the second UPF is equal to that in the terminal address pool. For example, the IP addresses in the IP address pool of the first UPF and the IP addresses in the IP address pool of the second UPF each account for 50% of the terminal address pool. It should be noted that the proportion of IP addresses from the terminal address pool allocated to the first UPF and the second UPF is not limited to being equally divided.

In a case that the type of the terminal address pool is fixed acquisition, the IP address pools of the first UPF and the second UPF are exactly the same, and both are IP addresses in the terminal address pool. In a case that the user terminal accesses the DNN, the UPF configured as the active apparatus in the first UPF and the second UPF obtains the fixed IP address corresponding to the user terminal from the UDM, and establishes the PDU session with the user terminal through the fixed IP address.

As shown in FIG. 2, in a case that the type of the terminal address pool of the DNN is fixed acquisition and the SMF configures the first UPF and the second UPF in the active-standby mode, then the first UPF and the second UPF both contain all IP addresses in the terminal address pool of the DNN, so that the first UPF can be used as the active apparatus and the second UPF can be used as the standby UPF. For example, when the UPF and the private network gateway of a client are interconnected through a GRE tunnel, the route of the private network gateway of the client pointing to the user terminal address will prioritize the first UPF, with the secondary route to the second UPF. When the routes of the first UPF and the second UPF are both normal, the user terminal establishes the PDU session through the first UPF preferentially, i.e., the first UPF acquires the fixed IP address corresponding to the user terminal and establishes a connection with the user terminal through the fixed IP address, so as to achieve communication through an active link between the first UPF and the gateway of the client. When the first UPF fails, causing the active link to fail, the user terminal re-registers, and the second UPF establishes the PDU session with the user terminal. When the first UPF fails, keepalive detects that the route of the first UPF is unavailable, and the route of the first UPF is deleted, so that the route of the second UPF becomes the only route, and the user terminal performs communication through the standby link between the second UPF and the gateway of the client. If the UPF publishes the routes to the Internet through a Border Gateway Protocol (BGP), it can publish high and low routes through a BGP dynamic routing protocol. Under normal circumstances, the data network preferentially communicates with the user terminal through the route of the first UPF. When the first UPF fails, the data network can quickly sense the routing failure of the first UPF through the dynamic routing protocol and switch the link to the second UPF. The data network includes, but is not limited to, the Internet and private networks.

When the type of the terminal address pool of the DNN is the dynamic configuration, and the SMF configures the first UPF and the second UPF in the load balancing mode, the IP addresses in the terminal address pool can be evenly divided between the first UPF and the second UPF. It should be noted that the IP addresses in the terminal address pool can be evenly divided between the first UPF and the second UPF or divided in any proportion. If the UPF publishes the routes through the BGP dynamic routing protocol, then the first UPF and the second UPF publish their own routes respectively. Under normal circumstances, the data network communicates with the user terminal according to the corresponding route. When the first UPF fails, the PDU session of the user terminal is re-registered to the second UPF. The data network can quickly sense the routing failure of the first UPF through the dynamic routing protocol and switch the link to the second UPF, allowing the user terminal to communicate with the data network through the second UPF.

In S120, if the type of the terminal address pool configured for the target DNN is a dynamic configuration, then the SMF configures the first UPF and the second UPF in a load balancing mode to allocate IP addresses of the terminal address pool to the first UPF and the second UPF in a preset proportion, and the first UPF or the second UPF selects an IP address from respective IP address pool as a dynamic IP address of the user terminal accessing the target DNN, where the user terminal is capable of establishing a PDU session with the first UPF or the second UPF through the dynamic IP address.

In the embodiment of the present disclosure, when the type of the terminal address pool of the DNN is the dynamic configuration, the SMF configures the first UPF and the second UPF in the load balancing mode. Generally, the first UPF or the second UPF selects an unallocated IP address in the address pool as the dynamic IP address of the user terminal to facilitate the establishment of the PDU session with the user terminal. When one of the first UPF fails or the second UPF fails, the other normal UPF will allocate the dynamic IP address to the user terminal.

In S130, if the type of the terminal address pool configured for the target DNN is a fixed acquisition, then the SMF configures the first UPF and the second UPF in an active-standby mode to allocate the terminal address pool to both the first UPF and the second UPF, and one of the first UPF and the second UPF which is configured as an active apparatus determines a fixed IP address of the user terminal accessing the target DNN from the respective IP address pool, where the user terminal is capable of establishing the PDU session with the active apparatus through the fixed IP address.

In the embodiment of the present disclosure, when the type of the terminal address pool of the DNN is the fixed acquisition, the SMF configures the first UPF and the second UPF in the active-standby mode. If the first UPF is the active apparatus, the first UPF determines the fixed IP address of the user terminal accessing the DNN from the respective IP address pool, and the first UPF establishes the PDU session with the user terminal through the fixed IP address.

In some embodiments, for example, in this embodiment, after the step S110, the method further includes the following steps: if the target DNN is configured with both the terminal address pool with the type of dynamic configuration and the terminal address pool with the type of fixed acquisition, then the IP addresses in the terminal address pool with the type of dynamic configuration are evenly divided between the first UPF and the second UPF so as to configure the first UPF and the UPF in the load balancing mode; and the IP addresses in the terminal address pool with the type of fixed acquisition are allocated to both the first UPF and the second UPF so as to configure the first UPF and the second UPF in the active-standby mode.

In the embodiments of the present disclosure, when there are both terminal address pools with the type of dynamic configuration and the type of fixed acquisition under the same DNN, and the above two types of address pools are different, then the SMF can configure the first UPF and the second UPF in the active-standby mode for the terminal address pool with the type of fixed acquisition in the DNN, so that the IP address pools of the first UPF and the second UPF are the same, and the SMF can configure the first UPF and the second UPF in the load balancing mode for the terminal address pool with the type of dynamic configuration, so that the first UPF and the second UPF are allocated with the IP addresses in the terminal address pool in proportion, and the first UPF and the second UPF respectively publish routes corresponding to the IP address pools. This allows the PDU session to be established for the user terminals of different service types under the same DNN at the same time, thereby further improving the disaster recovery.

In some embodiments, for example, in this embodiment, the method for determining an IP address of a 5G user terminal may further include the following step: in the active-standby mode and in a case that the first UPF is the active apparatus, if the first UPF fails, then the first UPF interrupts the PDU session with the user terminal to enable the user terminal to establish the PDU session with the second UPF.

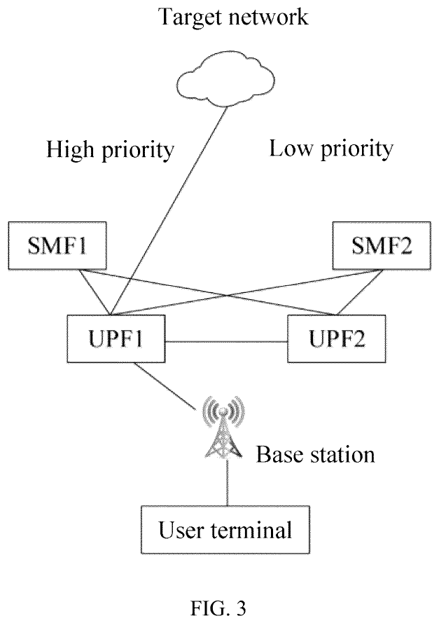

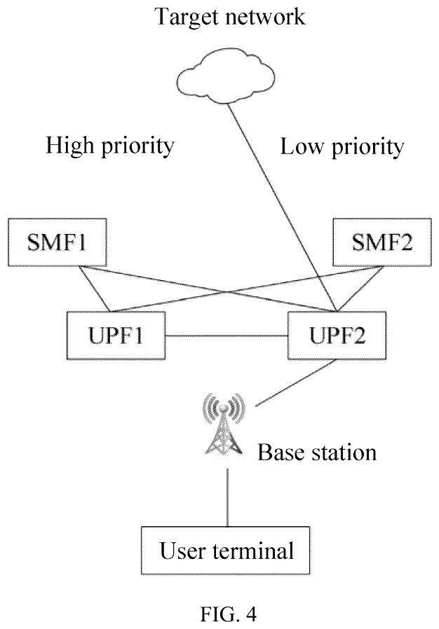

In the embodiment of the present disclosure, in the active-standby mode, after the user terminal establishes the PDU session with the data network through the first UPF, if the first UPF suddenly fails during the communication, the PDU session between the user terminal and the data network is interrupted, the user terminal will reinitiate a PDU session request and establish a PDU session with the data network through the second UPF. The user terminal communicates with the data network through the second UPF, as shown in FIGS. 3 and 4. When the first UPF returns to normal, the first UPF re-publishes its routes. As the first UPF is generally the active apparatus, the priority of the routes of the first UPF is generally higher than that of the second UPF. After the first UPF returns to normal, newly connected user terminal (initiating a new PDU session) will first establish a PDU session with the data network through the first UPF.

In some embodiments, for example, in this embodiment, after the first UPF interrupts, if the first UPF fails, the PDU session with the user terminal to enable the user terminal to establish the PDU session with the second UPF, the method further includes: if the second UPF receives a downlink message sent to the user terminal by the data network, whether an uplink message corresponding to the downlink message exists in the second UPF is determined; if the uplink message corresponding to the downlink message does not exists in the second UPF, whether the first UPF returns to normal is determined; and if the first UPF returns to normal, the downlink message is forwarded to the first UPF.

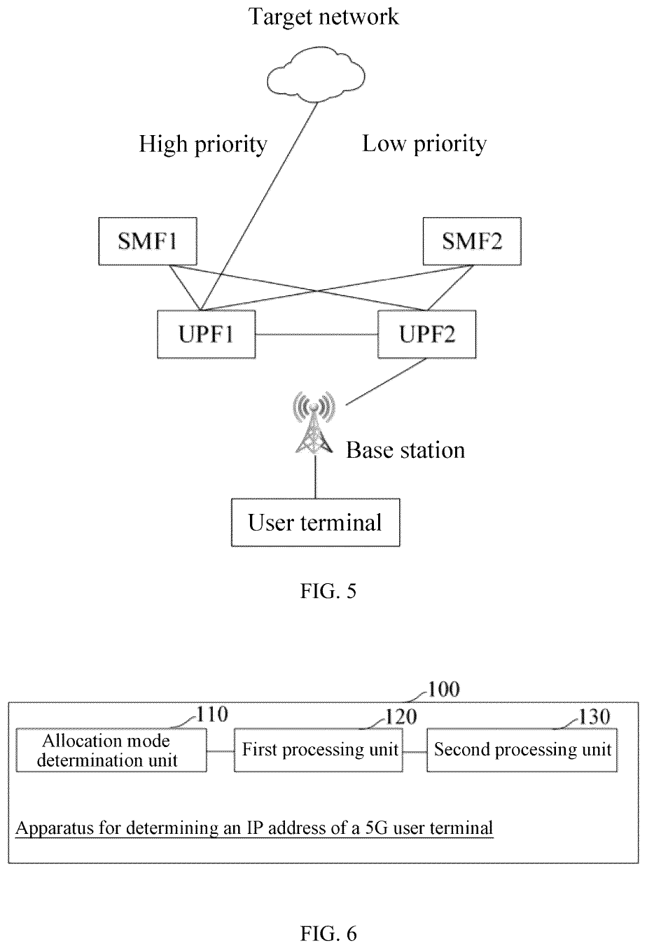

In the embodiment of the present disclosure, in the active-standby mode, after the first UPF fails, the user terminal re-establishes a communication connection with the data network through the second UPF. Since the user terminal has previously established the PDU session with the first UPF, and the user terminal has sent the uplink message to the data network through the first UPF, the data network will return the downlink message accordingly. If the first UPF fails at this time, the data network will send the downlink message to the second UPF, and the second UPF will send it to the user terminal. However, the second UPF does not have the uplink message corresponding to the downlink message. Generally, the second UPF will discard the message. In order to avoid this situation, the existing method is to kick all the user terminals of the second UPF offline after the first UPF returns to normal, so that the user terminal can re-establish a connection with the data network through the first UPF. However, this processing method is relatively time-consuming. As shown in FIG. 5, in the present disclosure, by establishing a GRE channel between the first UPF and the second UPF, and when the second UPF receives the downlink message, it is determined whether an uplink message corresponding to the downlink message exists, and it is also determined whether the first UPF returns to normal. If the first UPF returns to normal, then the downlink message will be forwarded to the first UPF, so that the downlink message can be sent to the user terminal through the first UPF. Of course, if the user terminal first establishes the connection with the data network through the first UPF, and then establishes the connection with the data network through the second UPF after the first UPF fails, and after the first UPF returns to normal, it establishes a connection again with the data network through the first UPF, the same judgment will be made when the first UPF receives a downlink message. If the uplink message corresponding to the downlink message exists in the second UPF, then the downlink message will be sent to the user terminal.

In some embodiments, for example, in the embodiment, forwarding the downlink message to the first UPF further includes the following step: a custom tag is added to the downlink message to indicate that the downlink message is a forwarded message; and the downlink message with the custom tag is forwarded to the first UPF.

In the embodiment of the present disclosure, when forwarding the downlink message, the second UPF may add a custom tag of “forwarded” to the downlink message to indicate the downlink message. When the first UPF receives the downlink message with the custom tag, even if the uplink message corresponding to the downlink message does not exist in the first UPF, it will not forward the downlink message to the second UPF.

In some embodiments, for example, in this embodiment, after forwarding the downlink message to the first UPF if the first UPF returns to normal, the method further includes: if the first UPF receives the downlink message, whether the uplink message corresponding to the downlink message exists in the first UPF is determined; if the uplink message corresponding to the downlink message exists in the first UPF, then the downlink message is sent to the user terminal; and if the uplink message corresponding to the downlink message does not exist in the first UPF, then the downlink message is discarded.

In the embodiment of the present disclosure, when the first UPF receives the downlink message forwarded by the second UPF, it will determine whether the uplink message corresponding to the downlink message exists. If it exists, then the downlink message will be sent to the user terminal, if not, it indicates that the user terminal does not establish the PDU session with the data network through the first UPF and the second UPF, then the downlink message may be discarded.

FIG. 6 is a schematic block diagram of an apparatus 100 for determining an Internet Protocol (IP) address of a 5G user terminal provided in an embodiment of the present disclosure. As shown in FIG. 6, corresponding to the method for determining an Internet Protocol (IP) address of a 5G user terminal, the present disclosure further provides an apparatus 100 for determining an Internet Protocol (IP) address of a 5G user terminal. The apparatus 100 for determining an Internet Protocol (IP) address of a 5G user terminal includes units for executing the method for determining an Internet Protocol (IP) address of a 5G user terminal. Specifically, referring to FIG. 6, the apparatus 100 for determining an Internet Protocol (IP) address of a 5G user terminal includes an allocation mode determination unit 110, a first processing unit 120, and a second processing unit 130.

The allocation mode determination unit 110 is configured to determine, by a Session Management Function (SMF) according to preset configuration information, a target Data Network Name (DNN) that matches with the SMF, and determine a type of a terminal address pool configured for the target DNN. The first processing unit 120 is configured to, if the type of the terminal address pool configured for the target DNN is a dynamic configuration, configure, by the SMF, the first UPF and the second UPF in a load balancing mode to allocate IP addresses of the terminal address pool to the first UPF and the second UPF in a preset proportion, and to select, by the first UPF or the second UPF, an IP address from respective IP address pools as a dynamic IP address of the user terminal accessing the target DNN, where the user terminal is capable of establishing a PDU session with the first UPF or the second UPF through the dynamic IP address. The second processing unit 130 is configured to, if the type of the terminal address pool configured for the target DNN is a fixed acquisition, configure, by the SMF, the first UPF and the second UPF in an active-standby mode to allocate the terminal address pool to both the first UPF and the second UPF, and to determine, by one of the first UPF and the second UPF which is configured as an active apparatus, a fixed IP address of the user terminal accessing the target DNN from the respective IP address pool, where the user terminal is capable of establishing the PDU session with the active apparatus through the fixed IP address.

Another embodiment of the present disclosure further provides a schematic block diagram of an apparatus for determining an Internet Protocol (IP) address of a 5G user terminal. The apparatus for determining an Internet Protocol (IP) address of a 5G user terminal in this embodiment is additionally provided with a third processing unit and a fourth processing unit based on the above embodiment.

The third processing unit is configured to, if the target DNN is configured with both the terminal address pool with the type of dynamic configuration and the terminal address pool with the type of fixed acquisition, allocate the IP addresses in the terminal address pool with the type of dynamic configuration evenly to the first UPF and the second UPF so as to configure the first UPF and the UPF in the load balancing mode. The fourth processing unit is configured to allocate the IP addresses in the terminal address pool with the type of fixed acquisition to both the first UPF and the second UPF so as to configure the first UPF and the second UPF in the active-standby mode.

Another embodiment of the present disclosure further provides a schematic block diagram of an apparatus for determining an Internet Protocol (IP) address of a 5G user terminal. The apparatus for determining an Internet Protocol (IP) address of a 5G user terminal provided in the embodiment of the present disclosure is additionally provided with an interrupting unit based on the above embodiments.

The interrupting unit is configured to, in the active-standby mode and in a case that the first UPF is the active apparatus, if the first UPF fails, interrupt, by the first UPF, the PDU session with the user terminal to enable the user terminal to establish the PDU session with the second UPF.

Another embodiment of the present disclosure further provides a schematic block diagram of an apparatus for determining an Internet Protocol (IP) address of a 5G user terminal. The apparatus for determining an Internet Protocol (IP) address of a 5G user terminal in the embodiment is additionally provided with a first determination unit, a second determination unit, and a first forwarding unit based on the above embodiments.

The first determination unit is configured to, if the second UPF receives a downlink message sent to the user terminal by a data network, determine whether an uplink message corresponding to the downlink message exists in the second UPF. The second determination unit is configured to, if the uplink message corresponding to the downlink message does not exist in the second UPF, determine whether the first UPF returns to normal; and the first forwarding unit is configured to, if the first UPF returns to normal, forward the downlink message to the first UPF.

In some embodiments, for example, in this embodiment, the first forwarding unit includes a first adding unit and a second forwarding unit.

The first adding unit is configured to add a custom tag to the downlink message to indicate that the downlink message is a forwarded message. The second forwarding unit is configured to forward the downlink message with the custom tag to the first UPF.

Another embodiment of the present disclosure further provides a schematic block diagram of an apparatus for determining an Internet Protocol (IP) address of a 5G user terminal. The apparatus for determining an Internet Protocol (IP) address of a 5G user terminal in the embodiment is additionally provided with a first determination unit, a first sending unit, and a fifth processing unit based on the above embodiments.

The first determination unit is configured to, if the first UPF receives the downlink message, determine whether the uplink message corresponding to the downlink message exists in the first UPF. The first sending unit is configured to, if the uplink message corresponding to the downlink message exists in the first UPF, send the downlink message to the user terminal. The fifth processing unit is configured to, if the uplink message corresponding to the downlink message does not exist in the first UPF, discard the downlink message.

FIG. 3 is a schematic structural block diagram of a system for determining an Internet Protocol (IP) address of a 5G user terminal provided in an embodiment of the present disclosure. As shown in FIG. 3, the system for determining an Internet Protocol (IP) address of a 5G user terminal includes: a first User Plane Function (UPF) in communication connection to the user terminal and a data network respectively; a second UPF in communication connection to the user terminal and the data network respectively; and at least one Session Management Function (SMF) connected to the first UPF and the second UPF respectively and configured to configure the first UPF and the second UPF according to a type of a terminal address pool configured by a Data Network Name (DNN), where the type of the terminal address pool comprises a dynamic configuration and a fixed acquisition, and in the dynamic configuration, the SMF configures the first UPF and the second UPF in a load balancing mode, and in the fixed acquisition, the SMF configures the first UPF and the second UPF in an active-standby mode, the first UPF is an active apparatus, the second UPF is a standby apparatus, and the user terminal preferentially establishes a PDU session through the active apparatus.

In the present disclosure, each DNN is configured with the first UPF, the second UPF, and at least one SMF. The allocation mode of the user terminal in the DNN is determined by the SMF, and the SMF configures the first UPF and the second UPF according to the allocation mode of the user terminal.

When the first UPF and the second UPF are in the load balancing mode, the first UPF publishes high-priority routes and the second UPF publishes low-priority routes. When the first UPF and the second UPF are in the active-standby mode, the first UPF serves as the active apparatus, and the second UPF serves as the standby apparatus. In some cases, the DNN is configured with the terminal address pools with the types of dynamic configuration and fixed acquisition, so that the first UPF and the second UPF can be configured as both the load balancing mode and the active-standby mode according to the terminal address pools with the dynamic configuration and fixed acquisition.

In an embodiment, the first UPF and the second UPF are connected through a General Routing Encapsulation (GRE) tunnel.

In the active-standby mode, the first UPF and the second UPF can be connected through the GRE tunnel. When the first UPF receives the downlink message sent by the target network and does not have the uplink message corresponding to the downlink message, the first UPF sends the downlink message to the second UPF through the GRE tunnel, so that the second UPF sends the downlink message to the user terminal. Similarly, when the second UPF receives the downlink message sent by the data network and does not have the uplink message corresponding to the downlink message, the second UPF sends the downlink message to the first UPF through the GRE tunnel.

In the above embodiments, each embodiment is described with its own emphasis. For parts that are not described in detail in a certain embodiment, reference may be made to the relevant descriptions of other embodiments.

Obviously, those of ordinary skills in the art can make various changes and modifications to the present disclosure without departing from the gist and scope of the present disclosure. In this way, as long as these changes and modifications to the present disclosure fall within the scope of the claims of the present disclosure and equivalent technologies, the present disclosure is also intended to include these changes and modifications.

The above are merely specific embodiments of the present disclosure, but the protection scope of the present disclosure is not limited thereto. Those of ordinary skills in the art can readily contemplate various equivalent modifications or substitutions within the technical scope in the present disclosure, and these modifications or substitutions shall all fall within the scope of protection of the present disclosure. Therefore, the scope of protection of the present disclosure should be subject to the scope of protection of the claims.

What is claimed is:

1. A method for determining an Internet Protocol (IP) address of a 5G user terminal, applied to a system for determining an IP address of a 5G user terminal, wherein the system for determining an IP address of a 5G user terminal comprises a first User Plane Function (UPF) and a second UPF, and the method comprises:
determining, by a Session Management Function (SMF) and according to preset configuration information, a target Data Network Name (DNN) that matches with the SMF, and determining a type of a terminal address pool configured for the target DNN;
in response to the type of the terminal address pool configured for the target DNN being a dynamic configuration, configuring, by the SMF, the first UPF and the second UPF in a load balancing mode to allocate IP addresses of the terminal address pool to the first UPF and the second UPF in a preset proportion, and selecting, by the first UPF or the second UPF, an IP address from respective IP address pools as a dynamic IP address of the user terminal accessing the target DNN, wherein the user terminal is capable of establishing a Protocol Data Unit (PDU) session with the first UPF or the second UPF through the dynamic IP address; and
in response to the type of the terminal address pool configured for the target DNN being a fixed acquisition, configuring, by the SMF, the first UPF and the second UPF in an active-standby mode to allocate the terminal address pool to both the first UPF and the second UPF, and determining, by one of the first UPF and the second UPF which is configured as an active apparatus, a fixed IP address of the user terminal accessing the target DNN from the respective IP address pool, wherein the user terminal is capable of establishing the PDU session with the active apparatus through the fixed IP address.

2. The method for determining an IP address of a 5G user terminal according to claim 1, wherein after determining, by a Session Management Function (SMF) and according to preset configuration information, a target Data Network Name (DNN) that matches with the SMF, and determining a type of a terminal address pool configured for the target DNN, the method further comprises:
in response to the target DNN being configured with both the terminal address pool with the type of dynamic configuration and the terminal address pool with the type of fixed acquisition, allocating the IP addresses in the terminal address pool with the type of dynamic configuration evenly to the first UPF and the second UPF so as to configure the first UPF and the UPF in the load balancing mode; and
allocating the IP addresses in the terminal address pool with the type of fixed acquisition to both the first UPF and the second UPF so as to configure the first UPF and the second UPF in the active-standby mode.

3. The method for determining an Internet Protocol (IP) address of a 5G user terminal according to claim 1, further comprising:
in the active-standby mode and in a case that the first UPF is the active apparatus, in response to the first UPF failing, interrupting, by the first UPF, the PDU session with the user terminal to enable the user terminal to establish the PDU session with the second UPF.

4. The method for determining an IP address of a 5G user terminal according to claim 3, wherein after in response to the first UPF failing, interrupting, by the first UPF, the PDU session with the user terminal to enable the user terminal to establish the PDU session with the second UPF, the method further comprises:
in response to the second UPF receiving a downlink message sent to the user terminal by a data network, determining whether an uplink message corresponding to the downlink message exists in the second UPF;
in response to the uplink message corresponding to the downlink message not existing in the second UPF, determining whether the first UPF returns to normal; and
in response to the first UPF returning to normal, forwarding the downlink message to the first UPF.

5. The method for determining an IP address of a 5G user terminal according to claim 4, wherein forwarding the downlink message to the first UPF comprises:
adding a custom tag to the downlink message to indicate that the downlink message is a forwarded message; and
forwarding the downlink message with the custom tag to the first UPF.

6. The method for determining an IP address of a 5G user terminal according to claim 4, wherein after in response to the first UPF returning to normal, forwarding the downlink message to the first UPF, the method further comprises:
in response to the first UPF receiving the downlink message, determining whether the uplink message corresponding to the downlink message exists in the first UPF; and
in response to the uplink message corresponding to the downlink message existing in the first UPF, sending the downlink message to the user terminal.

7. The method for determining an IP address of a 5G user terminal according to claim 6, wherein after in response to the first UPF receiving the downlink message, determining whether the uplink message corresponding to the downlink message exists in the first UPF, the method further comprises:
in response to the uplink message corresponding to the downlink message not existing in the first UPF, discarding the downlink message.

8. An apparatus for determining an IP address of a 5G user terminal, comprising:
an allocation determination unit configured to determine, by a Session Management Function (SMF) and according to preset configuration information, a target Data Network Name (DNN) that matches with the SMF, and determine a type of a terminal address pool configured for the target DNN;
a first processing unit configured to, in response to the type of the terminal address pool configured for the target DNN being a dynamic configuration, configure, by the SMF, the first UPF and the second UPF in a load balancing mode to allocate IP addresses of the terminal address pool to the first UPF and the second UPF in a preset proportion, and to select, by the first UPF or the second UPF, an IP address from respective IP address pools as a dynamic IP address of the user terminal accessing the target DNN, wherein the user terminal is capable of establishing a PDU session with the first UPF or the second UPF through the dynamic IP address; and
a second processing unit, configured to, in response to the type of the terminal address pool configured for the target DNN being a fixed acquisition, configure, by the SMF, the first UPF and the second UPF in an active-standby mode to allocate the terminal address pool to both the first UPF and the second UPF, and to determine, by one of the first UPF and the second UPF which is configured as an active apparatus, a fixed IP address of the user terminal accessing the target DNN from the respective IP address pool, wherein the user terminal is capable of establishing the PDU session with the active apparatus through the fixed IP address.

9. A system for determining an IP address of a 5G user terminal, comprising:
a first User Plane Function (UPF) in communication connection to the user terminal and a data network respectively;
a second UPF in communication connection to the user terminal and the data network respectively; and
at least one Session Management Function (SMF) connected to the first UPF and the second UPF respectively, and configured to configure the first UPF and the second UPF according to a type of a terminal address pool configured by a Data Network Name (DNN), wherein the type of the terminal address pool comprises a dynamic configuration and a fixed acquisition, and in the dynamic configuration, the SMF configures the first UPF and the second UPF in a load balancing mode, and in the fixed acquisition, the SMF configures the first UPF and the second UPF in an active-standby mode, the first UPF is an active apparatus, the second UPF is a standby apparatus, and the user terminal preferentially establishes a PDU session through the active apparatus.

10. The system for determining an IP address of a 5G user terminal according to claim 9, wherein the first UPF and the second UPF are connected through a General Routing Encapsulation (GRE) tunnel.
